(19) United States
(12) Patent Application Publication
(10) Pub. No.: US 2007/0011045 A1
(43) Pub. Date: Jan. 11, 2007

(54) Method for advertising

(75) Inventor: Gordon S. Peck, Etobicoke (CA)

Correspondence Address: FOLEY & LARDNER LLP, 777 EAST WISCONSIN AVENUE, MILWAUKEE, WI, 53202-5306, US

(73) Assignee: Munch Marketing Inc.

(21) Appl. No.: 11/178,236

(22) Filed: Jul. 8, 2005

(30) Foreign Application Priority Data
Jul. 7, 2005 (CA) 2,511,687

(51) Int. Cl. G06Q 30/00

(52) U.S. Cl. 705/14

(57) ABSTRACT

A novel method for advertising is disclosed which has a consolidator obtaining rights from tabletop owners to place advertisements on their tabletops. Preferably, the tabletop owners also agree to place and maintain the advertisements provided by the consolidator, but the consolidator can provide its own placement and maintenance service if the tabletop owners are unwilling or unable to provide such service. Once the consolidator has obtained the necessary rights from the tabletop owners, the consolidator can lease the space on the tabletops to advertisers, or their agents. The consolidator can manufacture the specific advertisements for the advertiser, or can provide specifications for the advertiser to have their ads manufactured to. Preferably, the ads employed are manufactured to reasonably survive their expected placement time despite the likelihood that they will be exposed to food and/or beverage spills. Accordingly, advertisements printed on plastic materials, or laminated with plastic materials, are preferred.

### FIELD OF THE INVENTION

The present invention relates to a method for advertising. More specifically, the present invention relates to a method for consolidating advertising products and services for placing advertisements on food tabletops or the like.

### BACKGROUND OF THE INVENTION

Advertising strategies and methods continually improve. Once an advertiser has planned a campaign and created the advertisements for it, they must decide where to place the developed advertisements. Possible locations for placement of the advertisements include the conventional locations, such as outdoor advertising, newspapers and magazines, etc. and, more recently, less conventional locations such as poster boxes in public washrooms and/or printed plastic sheets applied to floors in public spaces, or to the front of escalator steps in airports and other high traffic public areas.

Among the considerations an advertiser makes in deciding where to place an ad are: the potential traffic (i.e.—number of people who will be exposed to the ad and their demographics); the relevance of the ad content to the location (i.e.—advertising beer at a Baseball Stadium is more relevant than advertising health insurance at a rock concert); the cost of placing the ad; etc. Clearly, it is always desired to be able to place an advertisement in a location wherein it will be viewed by a high number of people in a targeted demographic group, especially where the location can be rented at a reasonable price.

On the other side of the advertising business, many landlords or owners of commercial buildings and areas rent advertising locations within their holdings to advertisers to generate additional revenue. Examples include billboards on the exterior of buildings and poster boxes in the public areas of the buildings.

It is desired to develop and make available, in an efficient manner, a novel advertising location which will generate revenue for landlords while meeting advertisers criteria for placing advertisements.

### SUMMARY OF THE INVENTION

It is an object of the present invention to provide a novel method of consolidating and making available novel advertising locations which obviates or mitigates at least one disadvantage of the prior art.

According to a first aspect of the present invention, there is provided a method of advertising, comprising the steps of: acquiring the rights to place advertising materials on the tabletop surface of tables in a specified location; locating an advertiser who wishes to place advertisements on the tabletop surface of the tables in the specified location and granting them the right to place their advertisements on those tabletop surfaces for an agreed time period; placing the advertisements on the tabletops and to periodically check that the advertisements remain on the tabletops and remain functional and replacing any damaged or missing advertisements; and at the end of the agreed time period, replacing the advertisements with advertisements which have been agreed to be placed on the tabletop surfaces for a new agreed time period.

Preferably, the advertisements are affixed to the tabletop surface with a removable adhesive.

### BRIEF DESCRIPTION OF THE DRAWINGS

Preferred embodiments of the present invention will now be described, by way of example only, with reference to the attached Figures, wherein:

FIG. 1 shows a plan view of a tabletop with an advertisement on it, in accordance with the present invention; and

FIG. 2 shows a plan view of another tabletop with an advertisement on it, in accordance with the present invention.

### DETAILED DESCRIPTION OF THE INVENTION

A method of consolidating advertising locations and selling advertising space in those locations in accordance with the present invention comprises the steps of: a consolidator leasing, or otherwise obtaining, the exclusive rights to place advertisements on tabletops in restaurants, food courts and other public eating areas; the consolidator marketing to advertisers the rights to place the advertisements; the manufacture of the advertisements; and the placement and maintenance of the placed advertisements on the tabletops.

Specifically, the landlord, owner or operator (hereinafter the tabletop owner) of an area where food is consumed, such as a food court in a shopping mall, a coffee shop, a company cafeteria or a hospital cafeteria, etc. will be contracted to grant an exclusive right to advertise on the tabletops to the consolidator for an agreed compensation.

In some circumstances, the contract can include terms to define and/or limit the other advertising which can be placed in the contracted area. For example, in a food court in a shopping mall the food vendors will typically have the right to place their logos, or their vendor's logos (i.e.—Coke and Pepsi soft drink cups, etc.), and other advertising materials on their cups, plates and wrapping materials and the landlord will typically have the right to place poster boxes in the food court area to hold advertising posters, etc.

In such a case, the contract between the tabletop owner and the consolidator can include terms requiring the tabletop owner to contractually (typically as part of the food vendor's lease) limit the food vendors from including advertising materials for products and/or services other than those they offer—i.e.—a French Fry vendor will be restricted from including advertisements for a travel agency on their packaging and/or wrappings.

In cases where the food vendor is controlled by the landlord, such as within a corporate cafeteria, the contract can include terms to eliminate all, or almost all, other advertising materials.

In other cases, the contract can be established by the consolidator directly with a tabletop owner who is a food vendor that has tables in their non-public facilities for the public to use as part of their service. For example, a contract can be executed with coffee shops for the right to place ads on their tabletops. Such a contract would likely include terms which restrict the content of the advertisements to be placed on the tabletops to ads for products or services which do not directly compete with the business of the food vendor.

For example, a coffee shop would likely want to prohibit the placement of ads for other coffee shops, or even ads for other beverage products, but would have no difficulty with having advertisements for new cars, etc. being placed on their tables.

Once the contract has been agreed between the consolidator and the tabletop owner, the consolidator can market tabletop advertising services to advertisers. Again, a contract will be developed and executed by the consolidator and the advertiser to define the parameters of the placement of the ads. Any limitations on advertising content which have been agreed by the consolidator with the tabletop owner will be mirrored in the contract with the advertiser, along with terms defining the size of the ads, the period within which they will be displayed, etc.

If desired, the consolidator can manufacture the tabletop ad materials for the advertiser, or the consolidator can provide an appropriate set of specifications—including permitted sizes and configurations of the ads and suggested manufacturing and assembly techniques (i.e.—laminated card stock paper, etc.)—to the advertiser, who can then have the ads manufactured.

Preferably, the contract between the consolidator and the tabletop owner includes terms which require the tabletop owner to arrange for the placement and maintenance of the ads on the contracted tabletops. It is contemplated that the tabletop owner will have their janitorial or other staff place and maintain the ads on the table tops.

Alternatively, the consolidator can provide a placement and maintenance service if the tabletop owner is unable or unwilling to assume this task, but in such cases the consolidator will likely reduce the amount of the contract payment to the tabletop owner, which they would otherwise have been willing to make, to compensate for the increased costs associated with the consolidator placing and maintaining the ads.

In either case, it is further contemplated that, as part of the maintenance service for the advertisements, the tabletops will be checked at agreed periods and any missing or damaged advertisements will be replaced.

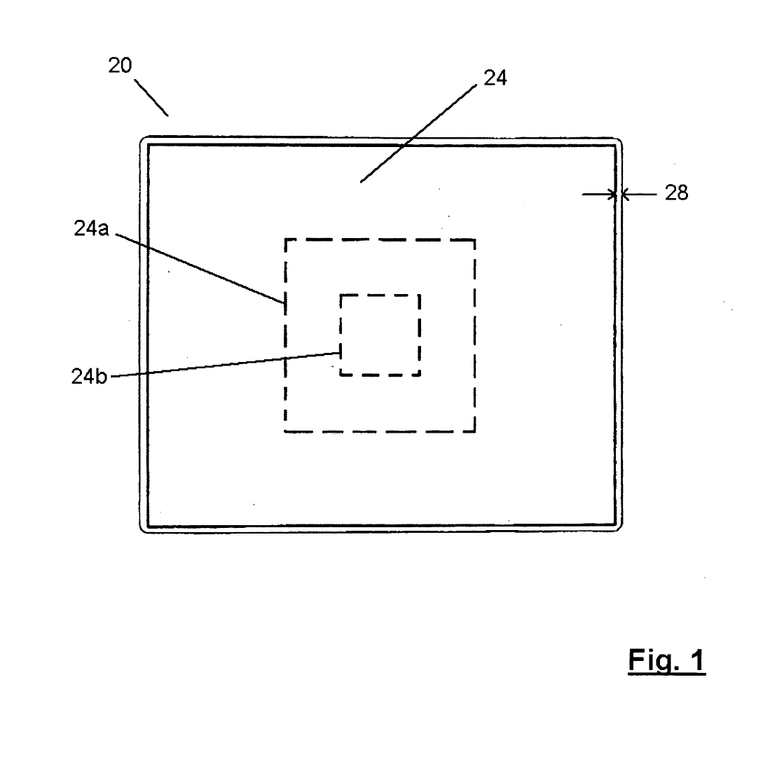

The actual construction of the tabletop ads is not particularly limited and can be accomplished in a variety of manners. FIG. 1 shows an example of a typical tabletop 20, which in this example is rectangular in shape. In this embodiment, the advertisement 24 for tabletop 20 is sized to cover tabletop 20, except for a small margin 28 about the outer periphery of advertisement 24.

Preferably, advertisement 24 is fabricated from heavy cardstock which has been plastic laminated on at least the upper surface to increase the durability of advertisement 24 and to provide resistance to liquid and/or food spills on advertisement 24. Depending upon the construction and finish of tabletop 20, advertisement 24 can be retained on tabletop 20 solely by gravity and friction, or by a static electrical charge, or by a removable adhesive, such as a fugitive adhesive.

The advertising content on advertisement 24 is preferably printed in color, through an appropriate offset process, but any other printing method can be employed including black and white printing, photographic or lithographic processes.

As will be apparent, the design and construction of advertisement 24 preferably will take into consideration the cost of producing advertisement 24, the durability of advertisement 24 in its expected tabletop environment (which is subject to frequent spills of food and drink), and the ease with which advertisement 24 can be deployed and replaced.

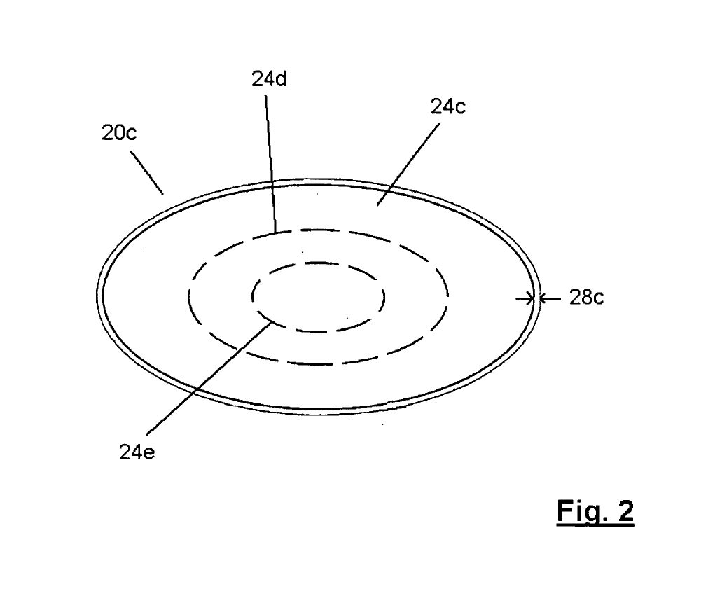

As will be apparent to those of skill in the art, advertisement 24 can be created in a variety of sizes, such as advertisements 24a and 24b indicated in dashed line in FIG. 1 and a variety of shapes, some of which are illustrated in FIG. 2.

In FIG. 2, tabletop 20c is oval in shape and advertisement 24c is a complementary shape and is sized to substantially cover tabletop 20c, except for a small margin 28c about the outer periphery of advertisement 24c. Again, advertisement 24c can be created in a variety of sizes, such as advertisements 24d and 24e indicated in dashed line in FIG. 2. Again, advertisement 24c can be affixed to tabletop 20c in a variety of manners including, without limitation, gravity and friction, or by a static electrical charge, or by a removable adhesive.

A novel method for advertising, in accordance with the present invention, has a consolidator obtaining rights from tabletop owners to place advertisements on their tabletops. Preferably, the tabletop owners also agree to place and maintain the advertisements provided by the consolidator, but the consolidator can provide its own placement and maintenance service if the tabletop owners are unwilling or unable to provide such service. Once the consolidator has obtained the necessary rights from the tabletop owners, the consolidator can lease the space on the tabletops to advertisers, or their agents. The consolidator can manufacture the specific advertisements for the advertiser, or can provide specifications for the advertiser to have their ads manufactured to. Preferably, the ads employed are manufactured to reasonably survive their expected placement time despite the likelihood that they will be exposed to food and/or beverage spills. Accordingly, advertisements printed on plastic materials, or laminated with plastic materials, are preferred.

The above-described embodiments of the invention are intended to be examples of the present invention and alterations and modifications may be effected thereto, by those of skill in the art, without departing from the scope of the invention which is defined solely by the claims appended hereto.

We claim:

1. A method of advertising, comprising the steps of:
acquiring the rights to place advertising materials on the tabletop surface of tables in a specified location;
locating an advertiser who wishes to place advertisements on the tabletop surface of the tables in the specified location and granting them the right to place their advertisements on those tabletop surfaces for an agreed time period;
placing the advertisements on the tabletops and to periodically check that the advertisements remain on the tabletops and remain functional and replacing any damaged or missing advertisements; and
at the end of the agreed time period, replacing the advertisements with advertisements which have been agreed to be placed on the tabletop surfaces for a new agreed time period.

2. The method of claim 1 wherein the advertisements placed on the tabletop surfaces are affixed thereto.

3. The method of claim 2 wherein the advertisements are affixed with a removable adhesive.

4. The method of claim 1 wherein the advertisement substantially covers the tabletop surface.
